(19) United States
(12) Patent Application Publication
(10) Pub. No.: US 2022/0406230 A1
(43) Pub. Date: Dec. 22, 2022

(54) LIGHT GUIDE PLATE, DISPLAY DEVICE, INPUT DEVICE, AND ELECTRIC DEVICE

(71) Applicant: OMRON Corporation, Kyoto-shi, KYOTO (JP)

(72) Inventors: Yasuhiro TANOUE, Kyoto-shi (JP); Masayuki SHINOHARA, Kyoto-shi (JP); Yoshihiko TAKAGI, Kyoto-shi (JP)

(73) Assignee: OMRON Corporation, Kyoto-shi, KYOTO (JP)

(21) Appl. No.: 17/779,168

(22) PCT Filed: Dec. 8, 2020
(86) PCT No.: PCT/JP2020/045694

§ 371 Date: May 24, 2022

(30) Foreign Application Priority Data
Dec. 19, 2019 (JP) 2019-229198

(51) Int. Cl. G09F 19/12; G09F 19/14; G02B 30/56

(52) U.S. Cl. CPC G09F 19/125; G09F 19/14; G02B 30/56; G09F 13/18

(57) ABSTRACT

A light guide plate according to one or more embodiments may include a plurality of optical path changing units each converging incident light to a definite point. A stereoscopic image is formed in a space by a collection of a plurality of definite points. The stereoscopic image includes a plurality of faces not parallel to each other, the face is made up of a plurality of dots dispersedly arranged on the face, and a density of the plurality of dots on each of the faces is a value corresponding to a position of the face.

### TECHNICAL FIELD

The present invention relates to a light guide plate that displays an image in a space, a display device including the light guide plate, an input device including the display device, and an electric device including the display device or the input device.

### BACKGROUND ART

Patent Document 1 discloses an optical device that forms a stereoscopic image. The optical device includes a plurality of light convergence units. The light convergence unit has an optical surface on which light guided by the light guide plate is incident and which emits, from an outgoing surface, emission light in (i) a direction substantially converging on one convergence point or convergence line in the space, or (ii) a direction substantially diverging from one convergence point or convergence line in the space. The convergence points or the convergence lines are different from each other among the plurality of light convergence units, and a plurality of convergence points or convergence lines form an image in the space.

### PRIOR ART DOCUMENT

### Patent Document

Patent Document 1: Japanese Unexamined Patent Publication No. 2016-114929

### SUMMARY OF THE INVENTION

### Problems to be Solved by the Invention

However, in a case where an image having a plurality of faces not parallel to each other is formed by the display device disclosed in Patent Document 1, when the faces are formed by a uniform collection of convergence points or convergence lines, an image with poor stereoscopic effect is obtained. Patent Document 1 neither discloses nor suggests a method for improving stereoscopic effect in the case of forming such an image.

An object of one aspect of the present invention is to achieve a light guide plate or the like capable of displaying a stereoscopic image with an improved stereoscopic effect.

### Means for Solving the Problem

In order to solve the above problem, a light guide plate according to an aspect of the present invention is a light guide plate including a plurality of optical path changing units each configured to converge incident light to a corresponding definite point, the light guide plate forming a stereoscopic image in a space by a collection of a plurality of the definite points corresponding to the plurality of optical path changing units. The stereoscopic image includes a plurality of faces not parallel to each other, the face is made up of a plurality of dots dispersedly arranged on the face, and a density of the plurality of dots on each of the faces is a value corresponding to a position of the face.

### Effect of the Invention

According to one aspect of the present invention, it is possible to achieve a light guide plate or the like capable of displaying a stereoscopic image with an improved stereoscopic effect.

### BRIEF DESCRIPTION OF THE DRAWINGS

FIG. 1 is a view illustrating a specific example of a stereoscopic image formed by a light guide plate according to a configuration example.

FIG. 2 is a perspective view for explaining a principle of a display by the display device.

FIG. 3 is a view for explaining an example of a method for determining brightness of each of faces included in a stereoscopic image.

FIG. 4 is a graph illustrating an example of a relationship between the angle and the brightness of the face.

FIG. 5 is a graph illustrating a relationship between the brightness of the face and the density of dots.

FIG. 6 is a view explaining the arrangement of dots.

FIG. 7 is a view for explaining a method for determining brightness of a curved face when a stereoscopic image has the curved face.

FIG. 8 is a view explaining another specific example of the stereoscopic image formed by the light guide plate according to the configuration example.

FIG. 9 is a view illustrating a face in a stereoscopic image displayed by a display device according to a first modification.

FIG. 10 is a view illustrating a stereoscopic image displayed by a display device according to a second modification.

FIG. 11 is a view illustrating an input device according to a third modification.

FIG. 12 is a perspective view illustrating an example of a game machine to which the input device has been applied.

FIG. 13 is a view illustrating a state where the display device has been applied to a tail lamp of a vehicle.

FIG. 14 is a view illustrating a state where the display device has been applied to an input unit of an elevator.

FIG. 15 is a view illustrating a state where the display device has been applied to an input unit of an electronic bidet seat.

FIG. 16 is a perspective view of a display device according to a fifth modification.

FIG. 17 is a cross-sectional view illustrating the configuration of the display device according to the fifth modification.

FIG. 18 is a plan view illustrating the configuration of a display device according to the fifth modification.

FIG. 19 is a perspective view illustrating a configuration of an optical path changing unit included in the display device according to the fifth modification.

FIG. 20 is a perspective view illustrating the arrangement of the optical path changing units.

FIG. 21 is a perspective view illustrating a method for forming a stereoscopic image by the display device according to the fifth modification.

### MODE FOR CARRYING OUT THE INVENTION

Hereinafter, an embodiment according to one aspect of the present invention (hereinafter also referred to as “the embodiment”) will be described with reference to the drawings. However, the embodiment described below is merely an example of the present invention in all respects. It goes without saying that various improvements and modifications can be made without departing from the scope of the present invention.

### § 1 Application Example

First, a principle of a display by a display device including a light guide plate according to the present invention will be described. In the following, for convenience of description, a +X direction in FIG. 2 may be described as a front direction, a −X direction as a back direction, a +Y direction as an up direction, a −Y direction as a down direction, a +Z direction as a right direction, and a −Z direction as a left direction.

FIG. 2 is a perspective view for explaining a principle of a display by a display device 10. The display device 10 forms a stereoscopic image, visually recognized by a user, in a space without a screen. FIG. 2 illustrates a state where the display device 10 displays a stereoscopic image I, more specifically, a button-shaped stereoscopic image I on which characters “ON” are displayed. As illustrated in FIG. 2, the display device 10 includes a light guide plate 11 and a light source 12. According to the display device 10, it is possible to display an image formed by the light guide plate 11 using the light from the light source 12.

The light guide plate 11 guides light incident from the light source 12 and emits the light from an outgoing surface 11a to form a stereoscopic image in the space. The light guide plate 11 has a rectangular parallelepiped shape and is formed of a resin material with transparency and a relatively high refractive index. The material forming the light guide plate 11 may be, for example, polycarbonate resin, polymethyl methacrylate resin, glass, or the like. The light guide plate 11 includes an outgoing surface 11a (light exit surface) that emits light, a back surface 11b opposite to the outgoing surface 11a, and an end surface 11c, an end surface 11d, an end surface 11e, and an end surface 11f, which are four end surfaces. The end surface 11c is an incident surface on which light projected from the light source 12 is incident on the light guide plate 11. In the following description, the end surface 11c is referred to as an incident surface 11c. The end surface 11d is a surface opposite to the end surface 11c. The end surface 11e is a surface opposite to the end surface 11f. The light guide plate 11 spreads and guides the light from the light source 12 on the surface in a plane parallel to the outgoing surface 11a. The light source 12 is a point light source that makes light incident on the light guide plate 11. Specifically, the light source 12 is, for example, a light-emitting diode (LED) light source.

On the back surface 11b of the light guide plate 11, a plurality of optical path changing units 13 including an optical path changing unit 13a, an optical path changing unit 13b, and an optical path changing unit 13c are formed. The optical path changing units 13 are formed substantially continuously in the Z-axis direction. In other words, the plurality of optical path changing units 13 are formed along predetermined lines, respectively, in the plane parallel to the outgoing surface 11a. Light projected from the light source 12 and guided by the light guide plate 11 is incident on each position in the Z-axis direction of the optical path changing unit 13. The optical path changing unit 13 substantially converges the light incident on each position of the optical path changing unit 13 to a definite point corresponding to each optical path changing unit 13. FIG. 2 particularly illustrates the optical path changing unit 13a, the optical path changing unit 13b, and the optical path changing unit 13c as some of the optical path changing units 13. FIG. 2 also illustrates how a plurality of light beams emitted from each of the optical path changing unit 13a, the optical path changing unit 13b, and the optical path changing unit 13c converge in the optical path changing unit 13a, the optical path changing unit 13b, and the optical path changing unit 13c, respectively.

Specifically, the optical path changing unit 13a corresponds to a definite point PA of the stereoscopic image I. Light from each position of the optical path changing unit 13a converges on the definite point PA. Thus, the wavefront of the light from the optical path changing unit 13a becomes a wavefront of light that appears as if being emitted from the definite point PA. The optical path changing unit 13b corresponds to the definite point PB on the stereoscopic image I. Light from each position of the optical path changing unit 13b converges on definite point PB. As described above, the light from each position of the arbitrary optical path changing unit 13 substantially converges on the definite point corresponding to each optical path changing unit 13. Thereby, the arbitrary optical path changing unit 13 can provide a wavefront of light that appears as if being emitted from the corresponding definite point. The definite points corresponding to the respective optical path changing units 13 are different from each other, and the stereoscopic image I recognized by the user is formed on the space (more specifically, in the space on the outgoing surface 11a side from the light guide plate 11) by a collection of a plurality of definite points corresponding to the optical path changing units 13.

As illustrated in FIG. 2, the optical path changing unit 13a, the optical path changing unit 13b, and the optical path changing unit 13c are formed along a line La, a line Lb, and a line Lc, respectively. Here, the line La, the line Lb, and the line Lc are straight lines substantially parallel to the Z-axis direction. The arbitrary optical path changing unit 13 is formed substantially continuously along a straight line parallel to the Z-axis direction.

### § 2 Configuration Example

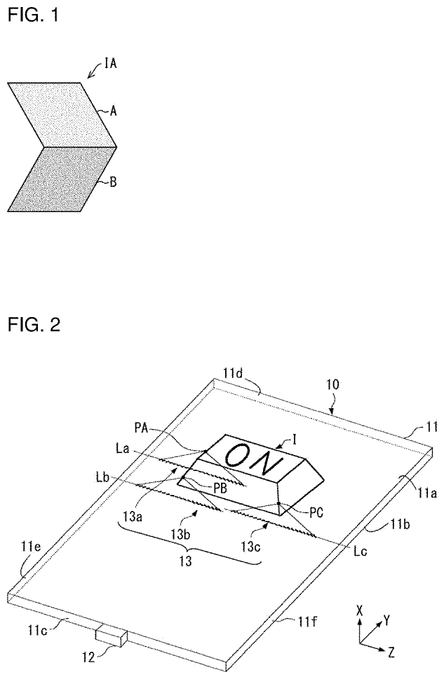

FIG. 1 is a view illustrating a stereoscopic image IA which is a specific example of a stereoscopic image I formed by the light guide plate 11 according to the embodiment. As illustrated in FIG. 1, the stereoscopic image IA has faces A, B that are not parallel to each other. FIG. 1 illustrates a state where faces A, B being rectangles are joined at one side of each of the rectangles and the one side is inclined with respect to the paper surface for the stereoscopic image IA.

The faces A, B include a plurality of dots dispersedly arranged on the faces A, B. A dot is an image of a point of light, which is formed at a point in the space. The density of the plurality of dots on each of the faces A, B is a value corresponding to the positions of the faces A, B. Therefore, the light guide plate 11 facilitates recognition of each of the faces A, B and can improve the stereoscopic effect of the stereoscopic image IA.

The display device 10 can also display a stereoscopic image having more flat faces than the stereoscopic image IA. Further, the display device 10 can display not only a flat face but also a stereoscopic image having a curved face such as a sphere. The curved face may be displayed as a set of many minute faces or may be displayed as one curved face.

The density of the dots on each of the faces A, B is determined in accordance with an angle between the normal direction of the face and a predetermined direction. Specifically, (i) the brightness of each of the faces A, B is determined in accordance with the above angle, and (ii) the density of the dots on each of the faces A, B is determined in accordance with the above brightness.

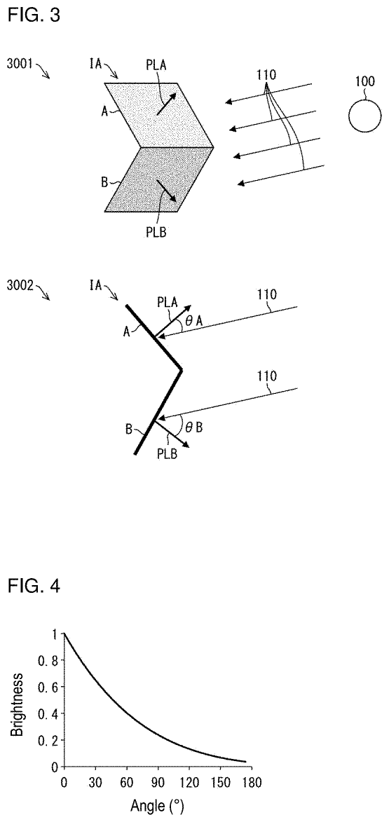

FIG. 3 is a view for explaining an example of a method for determining the brightness of each of the faces A, B. The method described below is a method for reproducing brightness in a case where a stereoscopic image is irradiated with light from a predetermined direction. In this method, as indicated by reference numeral 3001 in FIG. 3, a virtual light source 100 is set, which is a virtual light source for irradiating the stereoscopic image IA with light 110 from a predetermined direction. It is assumed that the virtual light source 100 is located at infinity with respect to the stereoscopic image IA. That is, the direction (predetermined direction) in which the light 110 is incident on the stereoscopic image IA from the virtual light source 100 is constant regardless of the position on the stereoscopic image IA. Then, as indicated by reference numeral 3002 in FIG. 3, angles θA, θB between the directions of respective normals PLA, PLB of the faces A, B and the direction of the light 110 are calculated.

FIG. 4 is a graph illustrating an example of a relationship between the angles θA, θB and the brightnesses of the faces A, B. In FIG. 4, the horizontal axis represents an angle, and the vertical axis represents brightness. The value of the brightness in FIG. 4 is a value normalized with the minimum value as 0 and the maximum value as 1. In the example illustrated in FIG. 4, the brightnesses of the faces A, B increase as the angles θA, θB decrease. By setting the brightness in this manner, how the light from the virtual light source 100 hits can be reproduced. However, the relationship between the angle and the brightness and the range of the angle that defines the relationship are not limited to the curve illustrated in FIG. 4, but may be set freely.

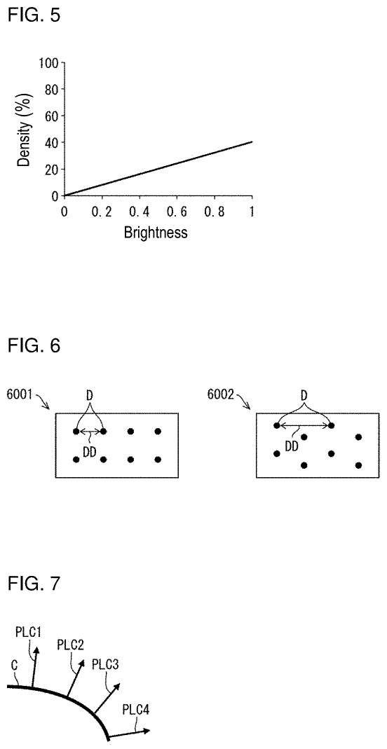

FIG. 5 is a graph illustrating a relationship between the brightnesses of the faces A, B and the densities of the dots. In FIG. 5, the horizontal axis represents the brightnesses of the faces A, B, and the vertical axis represents the densities of the dots. The densities of the dots on the faces A, B monotonously increase as the brightnesses of the faces A, B increase. In the example illustrated in FIG. 5, the densities of the dots are proportional to the brightnesses of the faces A, B. The light guide plate 11 capable of forming the stereoscopic image IA can be manufactured by forming the optical path changing unit 13 on the back surface 11b of the light guide plate 11 such that dots are arranged on each of the faces A, B at the density determined based on the relationship as illustrated in FIG. 5.

The density of the dots is appropriately determined in accordance with the design of the stereoscopic image IA. For example, when the stereoscopic image IA is designed to be bright as a whole, the density of the dots is increased as a whole. However, when the densities of the dots on the faces A, B are excessive, the faces A, B become faces that appear as if being filled, and the stereoscopic effect of the stereoscopic image IA decreases. The upper limit of the density of the dots is preferably 50%. When the upper limit of the dot density is 50%, it is possible to prevent the degradation of the stereoscopic effect of the stereoscopic image IA due to the excessive density of dots.

FIG. 6 is a view explaining the arrangement of dots D. The individual dots may be arranged randomly. However, the dot shape is likely to be blurred in a direction parallel to the incident surface 11c of the light guide plate 11. Therefore, as indicated by reference numeral 6001 in FIG. 6, when an interval DD between a plurality of dots D adjacent in the direction parallel to the incident surface 11c is shorter than the distance in which the dots D spread due to the blurring, the blurring occurs in the dots D, so that the dots D may be visually recognized as connected lines instead of individual dots D. In this case, the stereoscopic effect of the stereoscopic image IA may deteriorate.

Therefore, as indicated by reference numeral 6002 in FIG. 6, the interval DD between a plurality of dots D adjacent to each other in the direction parallel to the incident surface 11c is preferably equal to or more than a predetermined threshold. The predetermined threshold may be set to a distance at which, when blurring occurs in a plurality of adjacent dots D in the direction parallel to the incident surface 11c, the dots D are not connected to each other. By arranging a plurality of dots D in this manner, even when blurring occurs in the dots D, the dots D are easily visually recognized individually, so that the possibility of lowering the stereoscopic effect of the stereoscopic image IA can be reduced.

Further, as described above, the curved face can be displayed in the display device 10. However, the normal of the curved face is not uniquely determined, unlike the normal of the flat face. Therefore, the density of dots on the curved face is determined in accordance with, for example, an angle between a direction representing the curved face and a predetermined direction.

FIG. 7 is a view for explaining a method for determining the brightness of a face C that is a curved face when the stereoscopic image I has the face C. FIG. 7 illustrates normals PLC1, PLC2, PLC3, PLC4 at four different points on the face C. The directions of the normals PLC1 to PLC4 are different from each other. Examples of a method for determining the brightness of the face C include a method in which a direction of an arbitrary normal on the face C is set as a direction representing the face C, and the density of dots is determined in accordance with an angle between the direction and the direction of the light 110.

For example, a case where the direction of the normal PLC 3 is a direction representing the face C will be considered. In this case, an angle between the direction of the normal PLC 3 and the direction of the light 110 is calculated. Then, the brightness determined based on the calculated angle is defined as the brightness of the entire face C, and the density of dots determined based on the brightness is defined as the density of the dots in the entire face C.

The density of the dots does not necessarily need to be determined in the manner described above. The brightness of the faces A, B may be freely (e.g., the brightness of the face A is 1.0, and the brightness of the face B is 0.5) determined regardless of the above method, and the density of the dots may be determined based on the brightness in accordance with the relationship illustrated in FIG. 5. Specifically, there is an example in which the brightness is determined for each gradation of the original color of the stereoscopic image IA. Even in a case where the brightness is determined in this manner, making the brightness different for each face facilitates separate recognition of the faces. Therefore, the stereoscopic effect of the stereoscopic image IA can be improved as compared to a case where each face is formed uniformly. Two or more virtual light sources 100, which irradiate the stereoscopic image IA with the light 110 from directions different from each other, may be set, and the brightnesses by the respective virtual light sources 100 may be added up to obtain the final brightness.

### § 3 Operation Example

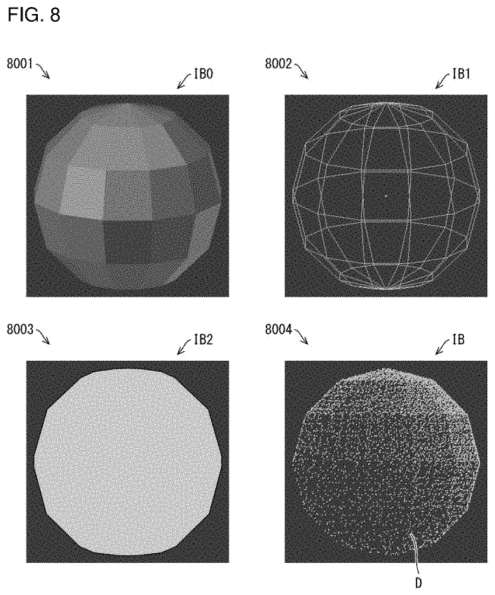

FIG. 8 is a view explaining a stereoscopic image IB that is another specific example of the stereoscopic image I formed by the light guide plate 11. In FIG. 8, a three-dimensional (3D) model IB0 to be expressed by the stereoscopic image IB is indicated by reference numeral 8001. A stereoscopic image IB1 in which the 3D model IB0 is represented only by contour lines is indicated by reference numeral 8002. A stereoscopic image IB2 in which each face included in the 3D model IB0 is filled is indicated by reference numeral 8003. A stereoscopic image IB obtained by forming the 3D model IB0 by the light guide plate 11 is indicated by reference numeral 8004.

In the stereoscopic image IB1, since the face of the 3D model IB0 is not displayed, the 3D model IB0 cannot be expressed. On the other hand, in the stereoscopic image IB2, since all the faces are displayed in the same manner, the respective faces cannot be recognized separately, and the stereoscopic effect of the 3D model IB0 cannot be expressed.

In contrast, in the stereoscopic image IB, the dots D are arranged at different densities on each face. That is, the plurality of faces are displayed by dots D arranged at different densities. Therefore, according to the stereoscopic image IB, each face of the 3D model made up of a plurality of faces is easily recognized separately, and a stereoscopic effect is easily felt, as compared to the stereoscopic images IB1 and IB2. In other words, the light guide plate 11 can form the stereoscopic image IB with an improved stereoscopic effect as compared to the stereoscopic images IB1 and IB2. Therefore, the light guide plate 11 widens the range of representation of the stereoscopic image IB as compared to the conventional light guide plate.

### § 4 Modifications

Although the embodiments of the present invention have been described in detail above, the above description is merely an example of the present invention in all respects. It goes without saying that various improvements and modifications can be made without departing from the scope of the present invention. For example, the following modifications are possible. Hereinafter, the same reference numerals are used for the same constituent elements as those in the above embodiment, and the same description as in the above embodiment is omitted as appropriate. The following modifications can be combined as appropriate.

<4.1>

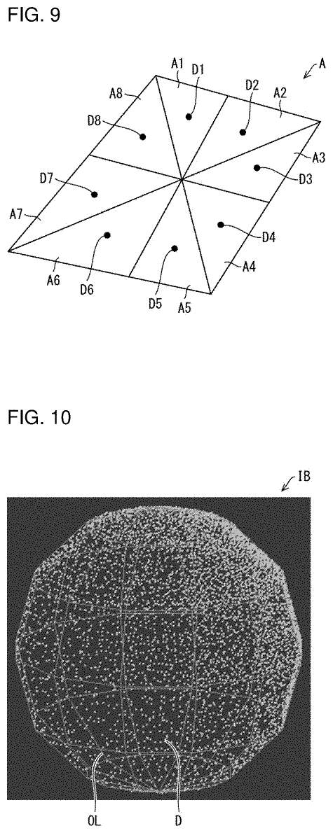

FIG. 9 is a view illustrating a face A in a stereoscopic image IA displayed by a display device 10 according to a first modification. In the configuration example described above, the dots indicating the face A have been arranged randomly. In contrast, in the first modification, as illustrated in FIG. 9, dots D1 to D8 are arranged at centers of gravity of respective triangles when the face A is subdivided into triangular areas A1 to A8. By arranging dots regularly in this manner, the appearance of the face A can be improved.

However, as described above, the plurality of dots are preferably arranged at different positions in a direction perpendicular to the incident surface 11c. Therefore, when the positions of the plurality of dots overlap in the direction perpendicular to the incident surface 11c by arranging the dots by the method according to the first modification, it is preferable to appropriately change the positions.

In the example illustrated in FIG. 9, the face A has been subdivided into eight areas A1 to A8 in consideration of visibility. However, the number of areas into which the face is actually subdivided may be appropriately determined in accordance with the dot density and size of the face. The shape of each area is not limited to a triangle.

Further, randomly arranged dots as in the configuration example described above and regularly arranged dots as in the first modification may be mixed on the face A. In this case, it is possible to uniformly arrange the dots while appropriately maintaining randomness, and further improve the appearance.

<4.2>

FIG. 10 is a view illustrating a stereoscopic image IB displayed by a display device 10 according to a second modification. As illustrated in FIG. 10, in the second modification, the stereoscopic image IB further includes a contour line OL of each face in addition to a dot D indicating each face included in the 3D model IB0. According to the second modification, it is possible to clearly display the details of the face of the stereoscopic image IB. The stereoscopic effect of the stereoscopic image IB can be emphasized by clarifying the contour of each face.

<4.3>

FIG. 11 is a view illustrating an input device 20 according to a third modification. As illustrated in FIG. 11, the input device 20 includes the display device 10 and a sensor 24. The sensor 24 detects an object in a non-contact manner in the space where the stereoscopic image I is displayed by the display device 10. In the example illustrated in FIG. 11, the sensor 24 is a photoelectric sensor that irradiates the stereoscopic image I with light and detects an object by reflected light. However, the sensor 24 may be a photoelectric sensor of a type different from the example illustrated in FIG. 11. The sensor 24 may be a sensor except for the photoelectric sensor.

In the example illustrated in FIG. 11, the sensor 24 has been on the opposite side of the stereoscopic image I with respect to the display device 10. However, the installation position of the sensor 24 is not limited thereto, and the sensor 24 may be installed on one of the upper, lower, left, and right sides with respect to the stereoscopic image I on the same side as the stereoscopic image I with respect to the display device 10.

When a user performs an input operation on the stereoscopic image I displayed by the display device 10 with an indicator F such as a finger, the sensor 24 detects the indicator F, and the input device 20 receives the input. According to the input device 20, it is possible to achieve a switch that can be operated in a non-contact manner. Moreover, according to the input device 20, the display device 10 can form the stereoscopic image I with an improved stereoscopic effect to prompt the user to perform input.

<4.4>

An example of an electric device including the display device 10 or the input device 20 will be described below. In the following description, only an example in which one of the display device 10 and the input device 20 is applied to the electric device may be described. However, it goes without saying that the other may be applied depending on the application of the electric device or the like.

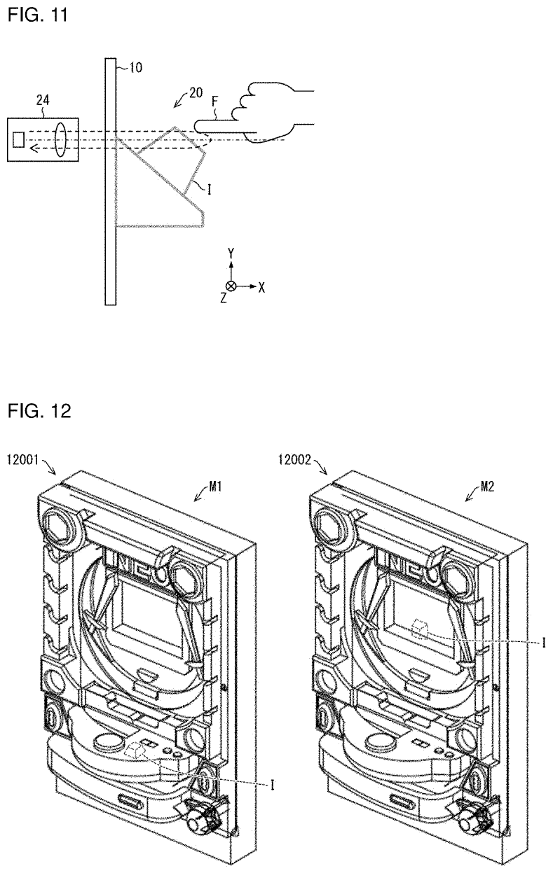

FIG. 12 is a perspective view illustrating examples of a game machine to which the input device 20 has been applied. In FIG. 12, the input device 20 is not illustrated. The input device 20 can be applied to an input device used in an amusement device such as a pachinko or pachinko-slot game machine. As described above, the input device 20 includes the display device 10 and the sensor 24. When a user performs an input operation on the image displayed by the display device 10 with an indicator such as a finger, the sensor 24 detects the indicator, and the input device 20 receives the input.

As indicated by reference numeral 12001 in FIG. 12, in an operation panel operated by the user on a game machine M1 (electric device), the display device 10 may form the stereoscopic image I as at least one of a plurality of switches operated by the user. As indicated by reference numeral 12002 in FIG. 12, the display device 10 may form the stereoscopic image I as a switch that is formed to be superimposed on the screen, on which a performance image for the user is displayed in a game machine M2 (electric device), and is to be operated by the user. In this case, the display device 10 may display the stereoscopic image I only when the display is necessary for performance. Only the display device 10 instead of the input device 20 may be applied to the game machine as a display device that displays an image for performance. The display device 10 may be applied to a game machine installed in a game center, a casino, or the like.

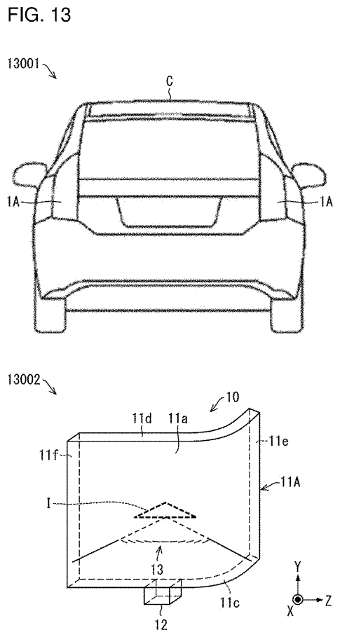

FIG. 13 is a view illustrating a state where the display device 10 is applied to a tail lamp of a vehicle C. The display device 10 can be applied to a tail lamp 1A (electric device) of the vehicle C, for example, as indicated by reference numeral 13001 in FIG. 13. In this case, the display device 10 includes a light guide plate 11A and the light source 12 as indicated by reference numeral 13002 in FIG. 13. The light guide plate 11A is different from the light guide plate 11 in that the light guide plate has a curved shape in accordance with the shape of the vehicle C. An optical path of light incident from the light source 12 is changed by the optical path changing unit 13 formed in the light guide plate 11A, whereby the stereoscopic image I is displayed. The display device 10 may be applied to a vehicle lamp other than the tail lamp or a vehicle display device.

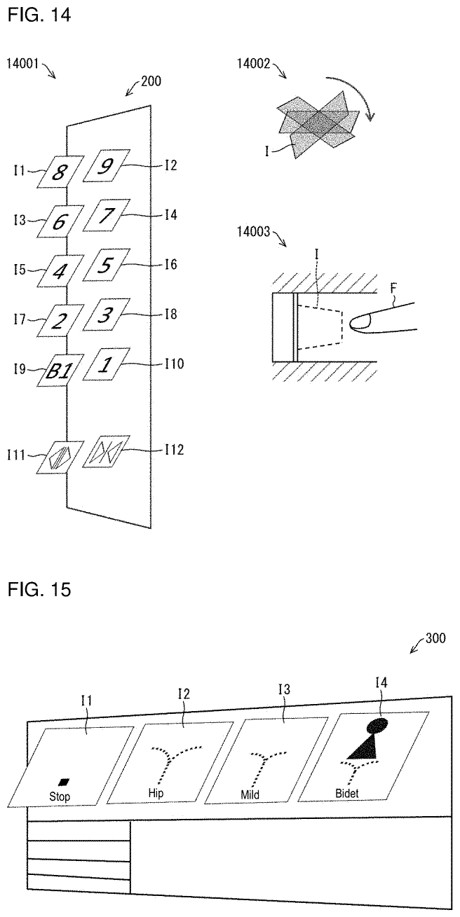

FIG. 14 is a view illustrating a state where the display device 10 has been applied to an input unit of an elevator. As indicated by reference numeral 14001 in FIG. 14, the display device 10 can be applied to, for example, the input unit 200 of the elevator. Specifically, the input unit 200 causes the display device 10 to display stereoscopic images 11 to 112. The stereoscopic images 11 to 112 are stereoscopic images formed with a display (stereoscopic images 11 to 110) for receiving an input from a user who specifies the destination (floor number) of the elevator or a display (stereoscopic images 111 and 112) for receiving an instruction to open and close the door of the elevator. When receiving the user's input to any of the stereoscopic images I, the input unit 200 changes the formation state of the stereoscopic image I (e.g., changes the color of the stereoscopic image I) and outputs an instruction corresponding to the input to the controller of the elevator. The display of the stereoscopic image I by the input unit 200 may be performed only when a person approaches the input unit 200. The input unit 200 may be disposed inside the wall of the elevator.

In the input unit 200 of the elevator, for example, when there are many people in the elevator, a part of the body of the user may be located at a position where the stereoscopic image I is formed, and the input unit 200 may receive an input not intended by the user. Therefore, in the input unit 200, the display device 10 may display a stereoscopic image I that urges the user to perform a rotation operation, for example, as indicated by reference numeral 14002 in FIG. 14. In this case, the input unit 200 may receive the user's input only when, for example, a motion sensor receives the rotation operation on the stereoscopic image I. Since the rotation operation is an operation that is not normally performed unless intended by the user, it is possible to prevent the input unit 200 from receiving an input not intended by the user. Further, as indicated by reference numeral 14003 in FIG. 14, the stereoscopic image I may be displayed in a recess provided in the inner wall of the elevator. Thereby, an input to the stereoscopic image I is performed only when the user's finger or the like is inserted into the recess, it is possible to prevent the input unit 200 from receiving an input not intended by the user.

FIG. 15 is a view illustrating a state where the display device 10 has been applied to an input unit of an electronic bidet seat. As illustrated in FIG. 15, the display device 10 can be applied to an input unit 300 (operation panel unit) of an electronic bidet seat, for example. Specifically, the input unit 300 causes the display device 10 to display the stereoscopic images 11 to 14. Stereoscopic images 11 to 14 are stereoscopic images formed with a display for receiving an instruction to drive or stop the cleaning functions of the electronic bidet seat. When receiving an input from a user to any of the stereoscopic images I, the input unit 300 changes the formation state of the stereoscopic image I (e.g., changes the color of the stereoscopic image I) and outputs an instruction corresponding to the input to the controller of the electronic bidet seat. Many users do not like to directly touch the operation panel of the electronic bidet seat in terms of hygiene. In contrast, in the input unit 300, the user can perform an operation without directly touching (physically touching) the input unit 300. Hence, the user can perform the operation without worrying about hygiene. Note that the input device of the present invention can also be applied to other devices, the direct touch of which are not preferable in terms of hygiene. For example, the input device of the present invention is suitably applied to a numbered ticket machine installed in a hospital, an operation unit of a moving door touched by an unspecified person, or the like. When there are a plurality of options such as surgery and medicine in the numbered ticket machine installed in the hospital, the input device of the present invention is suitable because the stereoscopic image I corresponding to each option can be displayed. Further, the input device of the present invention is suitably applied to a cash register or a food ticket machine installed in a restaurant.

In addition, the display device 10 can be applied to, for example, an input unit of an automated teller machine (ATM), an input unit of a credit card reader, an input unit for unlocking a safe, an input unit of a door that is unlocked by a personal identification number, or the like. Here, in the conventional personal identification number input device, the input is performed by physically touching the input unit with a finger. In such a case, a fingerprint and a temperature history remain in the input unit. For this reason, there has been a possibility that a personal identification number is known to another person. In contrast, when the display device 10 is used as the input unit, a fingerprint and a temperature history do not remain, so that it is possible to prevent a personal identification number from being known to others. As another example, the input device 20 can be applied to a ticket machine installed in a station or the like.

Moreover, the display device 10 can also be applied to an input device of a home appliance, such as an illumination switch of a washbasin, an operation switch of a faucet, an operation switch of a range hood, an operation switch of a dishwasher, an operation switch of a refrigerator, an operation switch of a microwave, an operation switch of an induction heating (IH) cooking heater, an operation switch of an electrolytic water generation device, an operation switch of an intercom, an illumination switch of a hallway, or an operation switch of a compact stereo system, an input device of a toy, or the like. By applying the display device 10 to these switches, there are advantages that (i) it is easy to clean since there is no unevenness in the switches, (ii) it is possible to display a stereoscopic image only when necessary, thus improving the design, (iii) it is hygienic since there is no need to contact the switches, and (iv) it is difficult to break since there is no movable part.

<4.5>

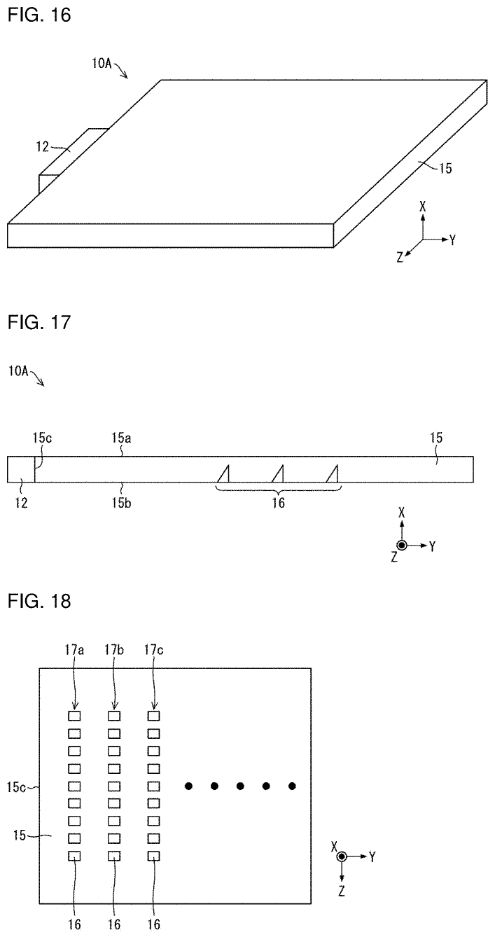

A display device 10A as a fifth modification will be described with reference to FIGS. 16 to 21.

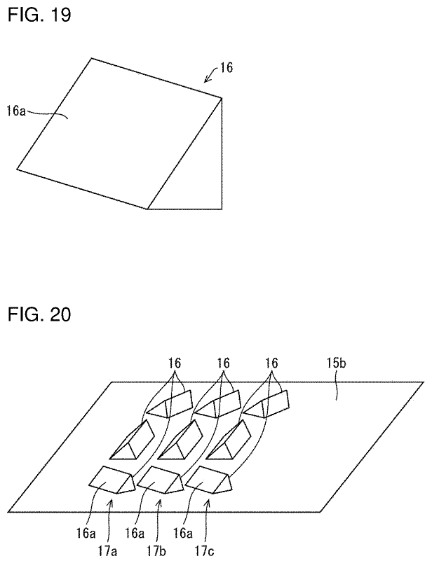

FIG. 16 is a perspective view of the display device 10A. FIG. 17 is a cross-sectional view illustrating the configuration of the display device 10A. FIG. 18 is a plan view illustrating the configuration of the display device 10A. FIG. 19 is a perspective view illustrating a configuration of an optical path changing unit 16 included in the display device 10A.

As illustrated in FIGS. 16 and 17, the display device 10A includes the light source 12 and a light guide plate 15 (first light guide plate).

The light guide plate 15 is a member that guides light (incident light) incident from the light source 12. The light guide plate 15 is formed of a transparent resin material with a relatively high refractive index. As a material for forming the light guide plate 15, for example, a polycarbonate resin, a polymethyl methacrylate resin, or the like can be used. In the modification, the light guide plate 15 is formed of polymethyl methacrylate resin. As illustrated in FIG. 17, the light guide plate 15 includes an outgoing surface 15a (light exit surface), a back surface 15b, and an incident surface 15c.

The outgoing surface 15a is a surface from which light is emitted, the light having been guided inside the light guide plate 15 and changed in its optical path by the optical path changing unit 16 to be described later. The outgoing surface 15a constitutes the front surface of the light guide plate 15. The back surface 15b is a surface parallel to the outgoing surface 15a and is a surface on which the optical path changing unit 16 to be described later is disposed. The incident surface 15c is a surface on which the light emitted from the light source 12 is incident on the light guide plate 15.

The light emitted from the light source 12 and incident on the light guide plate 15 from the incident surface 15c is totally reflected by the outgoing surface 15a or the back surface 15b and guided in the light guide plate 15.

As illustrated in FIG. 17, the optical path changing unit 16 is a member that is formed on the back surface 15b inside the light guide plate 15, changes the optical path of the light guided in the light guide plate 15, and emits the light from the outgoing surface 15a. A plurality of optical path changing units 16 are provided on the back surface 15b of the light guide plate 15.

As illustrated in FIG. 18, the optical path changing units 16 are provided along a direction parallel to the incident surface 15c. As illustrated in FIG. 19, the optical path changing unit 16 has a triangular pyramid shape and includes a reflection surface 16a that reflects (totally reflects) incident light. The optical path changing unit 16 may be, for example, a recess formed on the back surface 15b of the light guide plate 15. The optical path changing unit 16 is not limited to the triangular pyramid shape. As illustrated in FIG. 18, a plurality of optical path changing unit groups 17a, 17b, 17c, . . . each made up of a plurality of optical path changing units 16 are formed on the back surface 15b of the light guide plate 15.

FIG. 20 is a perspective view illustrating the arrangement of the optical path changing units 16. As illustrated in FIG. 20, in each of the optical path changing unit groups 17a, 17b, 17c, . . . , the reflection surfaces 16a of the plurality of optical path changing units 16 are arranged on the back surface 15b of the light guide plate 15 such that the angles with respect to the incident direction of light are different from each other. Thereby, each of the optical path changing unit groups 17a, 17b, 17c, . . . changes the optical path of the incident light and emits the incident light from the outgoing surface 15a in various directions.

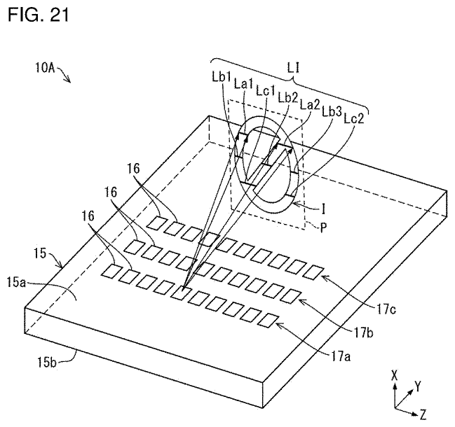

Next, a method for forming the stereoscopic image I by the display device 10A will be described with reference to FIG. 21. Here, a case will be described in which the stereoscopic image I as a plane image is formed on a stereoscopic image formed plane P, which is a plane perpendicular to the outgoing surface 15a of the light guide plate 15, by the light changed in its optical path by the optical path changing unit 16.

FIG. 21 is a perspective view illustrating the method for forming the stereoscopic image I by the display device 10A. Here, a description will be given of forming a ring mark with a diagonal line as the stereoscopic image I on the stereoscopic image formed plane P.

In the display device 10A, as illustrated in FIG. 21, for example, the light changed in its optical path by each optical path changing unit 16 of the optical path changing unit group 17a intersects with the stereoscopic image formed plane P on each of lines La1, La2. Thereby, a line image LI which is a part of the stereoscopic image I is formed on the stereoscopic image formed plane P. The line image LI is a line image parallel to the YZ plane. In this way, the line image LI of the lines La1, La2 is formed by the light from each of many optical path changing units 16 belonging to the optical path changing unit group 17a. Note that the light for forming the images of the lines La1, La2 may be provided by at least two optical path changing unit 16 in the optical path changing unit group 17a.

Likewise, the light changed in its optical path by each optical path changing unit 16 of the optical path changing unit group 17b intersects with the stereoscopic image formed plane P on each of lines Lb1, Lb2, Lb3. Thereby, a line image LI which is a part of the stereoscopic image I is formed on the stereoscopic image formed plane P.

The light changed in its optical path by each optical path changing unit 16 of the optical path changing unit group 17c intersects with the stereoscopic image formed plane P on each of lines Lc1 and Lc2. Thereby, a line image LI which is a part of the stereoscopic image I is formed on the stereoscopic image formed plane P.

The positions in the X-axis direction of the line images LI formed by the optical path changing unit groups 17a, 17b, 17c, . . . are different from each other. In the display device 10A, by reducing the distance between the optical path changing unit groups 17a, 17b, 17c, . . . , the distance in the X-axis direction of the line image LI formed by each of the optical path changing unit groups 17a, 17b, 17c, . . . can be reduced. As a result, the display device 10A accumulates a plurality of line images LI formed by the light changed in its optical path by each of the optical path changing units 16 of the optical path changing unit groups 17a, 17b, 17c, . . . , thus substantially forming the stereoscopic image I, which is a plane image, on the stereoscopic image formed plane P.

The stereoscopic image formed plane P may be a plane perpendicular to the X-axis, a plane perpendicular to the Y-axis, or a plane perpendicular to the Z-axis. Further, the stereoscopic image formed plane P may be a plane that is not vertical to the X-axis, the Y-axis, or the Z-axis. Moreover, the stereoscopic image formed plane P may be a curved surface instead of a plane. That is, the display device 10A can cause the optical path changing unit 16 to form the stereoscopic image I on an arbitrary plane (plane and curved surface) on the space. By combining a plurality of plane images, a three-dimensional image can be formed.

<4.6>

Light may be made incident on the light guide plate 11 from the end surface 11e or 11f by a light source different from the light source 12. In other words, the display device 10 may further include a light source different from the light source 12 that makes light incident on the light guide plate 11 from the end surface 11e or 11f. The color of the light emitted by another light source is different from the color of the light emitted by the light source 12.

In this case, the optical path changing unit 13 corresponding to the light source 12 and the optical path changing unit 13 corresponding to another light source are formed on the back surface 11b of the light guide plate 11. In the stereoscopic image I, the density of the dots of the light emitted from the light source 12 and the density of the dots of the light emitted from another light source are made different for each face, so that each of the plurality of faces of the stereoscopic image I can have different colors.

A light guide plate according to an aspect of the present invention is a light guide plate including a plurality of optical path changing units each configured to converge incident light to a corresponding definite point, the light guide plate forming a stereoscopic image in a space by a collection of a plurality of the definite points corresponding to the plurality of optical path changing units. The stereoscopic image includes a plurality of faces not parallel to each other, the face is made up of a plurality of dots dispersedly arranged on the face, and a density of the plurality of dots on each of the faces is a value corresponding to a position of the face.

With the above configuration, the face included in the stereoscopic image is made up of the plurality of dots, dispersedly arranged on the face, with a density corresponding to the position of the face. The brightness of the face varies depending on the density of the dots. It is thus possible to display a stereoscopic image with an improved stereoscopic effect as compared to, for example, a case where the face is made up of dots having a constant density.

Further, in the light guide plate according to one aspect of the present invention, it is preferable that the density of the plurality of dots on each of the faces be determined in accordance with a direction of a normal of the face or an angle between a direction representing the face and a predetermined direction.

With the above configuration, it is possible to reproduce the brightness on each face when it is assumed that light is incident on the stereoscopic image from a predetermined direction. It is thus possible to appropriately determine the brightness of each face in the stereoscopic image.

Further, in the light guide plate according to one aspect of the present invention, it is preferable that an upper limit of the density of the plurality of dots on each of the faces be 50%.

With the above configuration, it is possible to prevent degradation in the stereoscopic effect of the stereoscopic image due to an excessive dot density.

Further, in the light guide plate according to one aspect of the present invention, it is preferable that an interval between the plurality of dots adjacent to each other in a direction parallel to an incident surface on which the light is incident on the light guide plate is a predetermined threshold or more.

With the above configuration, even when blurring occurs in a plurality of dots in the direction parallel to the incident surface, it is possible to reduce the possibility that the dots are connected and visually recognized linearly.

Further, in the light guide plate according to one aspect of the present invention, it is preferable that the stereoscopic image further include contour lines of the plurality of faces.

With the above configuration, details of the end of the face can be expressed by the contour line.

Further, the display device according to one aspect of the present invention includes: the light guide plate; and a light source configured to make light incident on the light guide plate.

With the above configuration, the display device that displays the stereoscopic image with an improved stereoscopic effect can be achieved by making the light emitted from the light source incident on the light guide plate.

Further, an input device according to one aspect of the present invention includes: the display device; and a sensor configured to detect an object in a non-contact manner in a space where the stereoscopic image is displayed.

With the above configuration, it is possible to achieve the input device that detects the user's operation on the stereoscopic image with an improved stereoscopic effect by the sensor and receives the input.

An electric device according to an aspect of the present invention includes the display device or the input device.

With the above configuration, it is possible to improve the stereoscopic effect of the image displayed by the display device or the input device included in the electric device.
1A tail lamp (electric device)
10 display device
11 light guide plate
11a, 15a outgoing surface (light exit surface)
11c, 15c incident surface
12 light source
13, 13a, 13b, 13c, 16 optical path changing unit
20 input device
24 sensor
I, IA, IB stereoscopic image
A, B, C face
D, D1 to D8 dot
M1, M2 game machine (electric device)
OL contour line
PLA, PLB, PLC1, PLC2, PLC3, PLC4 normal
θA, θB angle

1. A light guide plate comprising:
a plurality of optical path changing units each configured to converge incident light to a corresponding definite point, the light guide plate forming a stereoscopic image in a space by a collection of a plurality of definite points corresponding to the plurality of optical path changing units, wherein
the stereoscopic image comprises a plurality of faces not parallel to each other,
the face is made up of a plurality of dots dispersedly arranged on the face, and
a density of the plurality of dots on each of the faces is a value corresponding to a position of the face.

2. The light guide plate according to claim 1, wherein the density of the plurality of dots on each of the faces is determined in accordance with a direction of a normal of the face or an angle between a direction representing the face and a predetermined direction.

3. The light guide plate according to claim 1, wherein an upper limit of the density of the plurality of dots on each of the faces is 50%.

4. The light guide plate according to claim 1, wherein an interval between the plurality of dots adjacent to each other in a direction parallel to an incident surface on which the light is incident on the light guide plate is a predetermined threshold or more.

5. The light guide plate according to claim 1, wherein the stereoscopic image further comprises contour lines of the plurality of faces.

6. A display device comprising:
the light guide plate according to claim 1; and
a light source configured to make light incident on the light guide plate.

7. An input device comprising:
the display device according to claim 6; and
a sensor configured to detect an object in a non-contact manner in a space where the stereoscopic image is displayed.

8. An electric device comprising the display device according to claim 6.

9. The light guide plate according to claim 2, wherein an upper limit of the density of the plurality of dots on each of the faces is 50%.

10. The light guide plate according to claim 2, wherein an interval between the plurality of dots adjacent to each other in a direction parallel to an incident surface on which the light is incident on the light guide plate is a predetermined threshold or more.

11. The light guide plate according to claim 3, wherein an interval between the plurality of dots adjacent to each other in a direction parallel to an incident surface on which the light is incident on the light guide plate is a predetermined threshold or more.

12. The light guide plate according to claim 2, wherein the stereoscopic image further comprises contour lines of the plurality of faces.

13. The light guide plate according to claim 3, wherein the stereoscopic image further comprises contour lines of the plurality of faces.

14. The light guide plate according to claim 4, wherein the stereoscopic image further comprises contour lines of the plurality of faces.

15. A display device comprising:
the light guide plate according to claim 2; and
a light source configured to make light incident on the light guide plate.

16. A display device comprising:
the light guide plate according to claim 3; and
a light source configured to make light incident on the light guide plate.

17. A display device comprising:
the light guide plate according to claim 4; and
a light source configured to make light incident on the light guide plate.

18. A display device comprising:
the light guide plate according to claim 5; and
a light source configured to make light incident on the light guide plate.

19. An electric device comprising the input device according to claim 7.
